(19) United States
(12) Patent Application Publication
(10) Pub. No.: US 2004/0247756 A1
(43) Pub. Date: Dec. 9, 2004

(54) Modified brown rice and method of producing the same

(76) Inventor: Kaku Imura, Wakayama-shi (JP)

Correspondence Address: LAW OFFICE OF BARRY R LIPSITZ, 755 MAIN STREET, MONROE, CT, 06468, US

(21) Appl. No.: 10/822,893

(22) Filed: Apr. 12, 2004

(30) Foreign Application Priority Data
Jun. 5, 2003 (JP) 2003-160786

(51) Int. Cl. A23L 3/00

(52) U.S. Cl. 426/482

(57) ABSTRACT

Provided is modified brown rice which can be cooked in completely the same manner as that of the white rice and is excellent in taste, mouthfeel, and digestion and absorption, while containing almost the same nutrient components as that of so-called brown rice which is obtained by removing only the rice hulls from the rice plant. The epidermal layer of brown rice is polished to remove the pericarp and a part of the seed coat underneath for partially exposing the tubular cell tissue covered under the seed coat to the surface of brown rice. At the same time, the oil and fat components inside the tube in the tubular cell tissue is removed to make a hollow inside the tube. Thereby, the modified brown rice can be achieved.

### BACKGROUND OF THE INVENTION

1. Field of the Invention

The present invention relates to modified brown rice and a method of producing the same. More specifically, it relates to new brown rice which can be easily cooked, is excellent in digestion and absorption and the taste, and whose active ingredients are preserved by polishing and removing only the epidermal layer, and to the method of producing the same.

2. Detailed Description of the Prior Art

Brown rice is a nutritionally balanced food item containing most of the nutrients necessary for the human body such as a carbohydrate, fat, protein, vitamins, and dietary fibers. Compared to white rice, it has been verified that brown rice contains about ten times as much as that of vitamin E, about four times of vitamin B1, about three times of vitamin B2, about three times of fibers, about twice as much of calcium and the like.

Because of the foregoing reasons along with the health food boom, brown rice has been discovered new merits and recommendation for eating brown rice has now been called out everywhere.

However, as it was inevitable that brown rice has shifted to white rice as a meal, there are various shortcomings in brown rice besides the advantages described above. The shortcomings are due to the biological structure of brown rice. FIG. 15 is a cross section showing a rough structure of a brown rice grain.

In the figure, numeral 1 shows the so-called a brown rice grain obtained by removing rice hulls from rice reaped from a rice plant. Numeral 2 is an epidermal layer, 3 is a tubular cell tissue which is also called as a mesocarp, 4 is an aleurone layer, 5 is an albumen, and 6 is an embryo bud. The so-called white rice is obtained by refining through removing the epidermal layer 2, the tubular cell tissue 3, the aleurone layer 4 and the embryo bud 6 as the rice bran leaving only the albumen 5.

Rice, when it is still unpolished, has many kinds of nutrients such as carbohydrate, fat, protein, vitamins, and dietary fibers. Especially, it is considered that there are biogenic substances which are hard to be identified in the embryo bud cardinal for germinating. Most of the substances are removed as the rice bran during the polishing step. Generally, the white rice referred to as white rice contains only protein and carbohydrate.

The brown rice has been discovered new merits once again for trying to ingest the above-described substances originally contained in rice. However, it is not easy for human beings to practically take in brown rice as a regular diet.

In other words, there are shortcomings in brown rice; it is difficult to be cooked as easily as the white rice, hard to be digested and absorbed, less tasty and the like.

Conventionally, for cooking the brown rice, it is necessary to immerse the rice in water for 5 hours or more, wash it, and then heat it for a long time. However, many of automatic rice cookers now are designed to cook white rice, so that the switches go off before reaching the time required for the starch of brown rice to be pregelatinized. Therefore, for cooking the brown rice, an ordinal pan, pot, or a special automatic rice cooker for brown rice have to be used.

The so-called brown rice obtained by removing only the rice hulls from a rice plant is hard to be digested and absorbed even if it is cooked by being sufficiently heated. It also has an unpleasant taste and hard to be taken as a regular diet.

The shortcomings of brown rice as described above are due to the biological structure of brown rice. FIG. 16 is a model figure showing the structure of brown rice shown in FIG. 15 in more detail.

The epidermal layer 2 comprises a pericarp 2a and a seed coat 2b inside the pericarp. There is a tubular cell tissue 3 also called as a mesocarp present inside the epidermal layer 2. Numeral 7 is a mucilage layer made of fat and protein or the like, which is an inner bran layer also being called as an aleurone layer formed inside the tubular cell tissue 3. Numeral 4 is the so-called an aleurone layer and 5 is a farinaceous albumen.

A rice wax film is formed on the surface of the pericarp 2b. This paraffin 2a hinders moisture contents from penetrating into the inside, which is one of the reasons for making it difficult to cook the brown rice.

Further, there are repellent substances having a laxative affect such as guanine, lignin and the like present in the rice wax film. Even they are safe to be taken in, it leads to stomachache when absorbed in large quantities, so that the brown rice is said to be indigestible and unabsorbable.

For germination of brown rice, the tubular cell tissue 3 takes in water from the end part of brown rice for promoting the germination while sending nutrient necessary for growing to the embryo bud 6 by supplying the water to the albumen 5. However, even when the intake part in the end part of the brown rice is in contact with water, the tubular cell tissue 3 does not take in the water immediately for supplying the water to the embryo bud 6 and the albumen 5. This is to avoid such a case that the supply of water stops after promoting the germination by supplying water, which hinders growing up of the germinated brown rice. In other words, the tubular cell tissue 3 supplies water to prescribed parts under the state where water is continuously supplied to rice in the hulls (same for brown rice) and, specifically, under the state where there is water continuously present in the intake part. Therefore, for cooking the brown rice, it is necessary to immerse the rice in water for 5 hours or more beforehand. It is then the tubular cell tissue 3 starts to supply water to the prescribed parts. There is a difference between the plant biogenic active time and the water supplement time for cooking the brown rice to be favorable to human beings. Thus, for brown rice as it is, the starch cannot be uniformly pregelatinized through heating by a heat-cooking step.

When cooking the brown rice, it has not been possible to obtain brown rice having a nice taste for human beings without going through immersion at least for 5 hours and washing or polishing.

Because of the foregoing reasons, when the brown rice is cooked in the same manner as that of the white rice, water is not present in the starch layer so that pregelatinization is insufficient and the cooked rice is to be hard and tasteless. Further, practically, there are micro scar holes opened on the surface of a part of brown rice generated during a threshing process and water permeates therefrom to the inside the starch layer at the time of cooking and, as it is heated, this flows out in a gruel state. On the other hand, the brown rice without water being permeated continues to be in the beta state which cannot be cooked forever. In other words, for pregelatinizing the starch without water being permeated, it is necessary to heat it at 200° C. and it is impossible to perform heating at such a high temperature using an ordinal pan or pot. In order to avoid such a case, it is necessary to immerse the brown rice for 5 hours or more, preferably overnight before cooking, so that it is not preferably used as a regular diet. Even if it is cooked after going through such a trouble, there are repellent substances as described having a laxative affect such as guanine, lignin and the like present in the rice wax film. Therefore, it may be indigestible and unabsorbable, so that it cannot be recommended for little children and patients.

On the other hand, it becomes unnecessary to immerse the brown rice in water for a long time when using a high-pressure cooker. However, active ingredients such as vitamins and pantothenic acid which are not suitable for high temperatures are to be decomposed and lost by the high temperature through applying pressure.

Also, a kind of active substance which is a biogenic substance contained in the embryo bud is to be lost.

### SUMMARY OF THE INVENTION

The object of the present invention is to achieve brown rice which can maintain the various active ingredients originally contained in brown rice after cooking and is excellent in digestion and absorption while each grains are uniformly expanded by heating to be pregelatinized without deformation and has a nice taste and mouthfeel by a simple cooking in the same manner as that of an ordinal white rice. Conventionally, this type of brown rice does not exist.

The present invention intends to resolve the above conventional problems by providing modified brown rice in which an epidermal layer of brown rice is polished to remove pericarp and also partially remove seed coat under the pericarp, thereby partially exposing tubular cell tissues covered with the seed coat on the surface of brown rice.

In the above mentioned brown rice, polishing the epidermal layer of brown rice is attained by using a brown rice treating apparatus, comprising a polishing drum with a supplying port of brown rice on one end and a discharge port of brown rice on the other end, and an axial-type polishing roll which rotates inside the polishing drum, and the surface of the polishing roll being at least partially provided with spiral protrusions to which polishing carbide particles such as diamond, sapphire or zirconia ceramic are fixed, and having such a structure that while brown rice grains introduced from the supplying port into the polishing drum are transported by the spiral protrusion of the polishing roll toward the discharge port, polishing and grinding can be given only to the epidermal layer of brown rice.

Moreover, in either the above modified brown rice, oil components in tubular cell tissues may be removed.

In the above modified brown rice removing oil components in tubular cell tissues, the removing of oil components in tubular cell tissues is performed by using a wash-free rice producing apparatus having a pressurizing stir means, a rinsing dehydration means and an evaporation means.

In the wash-free rice producing apparatus, the pressurizing stir means has a water-pouring port for adding washing water to white rice and houses a stir roll provided with spiral protrusions on the circumference surface rotatable in a freely driven mode inside a stirring drum provided with a receiving port for white rice on one end and a discharge port on the other end; the rinsing dehydration means is rotatable in a freely driven mode provided with a centrifugal dehydration chamber provided with a porous circumference wall, in which a screw drum is provided coaxially with the centrifugal dehydration chamber and in relation to the centrifugal dehydration chamber, a rice supplying tube for supplying white rice from the pressurizing stir means into the screw drum is passed through the screw drum, and the rinsing dehydration means also has a rice pouring port for pouring the white rice supplied from the rice supplying tube toward the circumference wall of the centrifugal dehydration chamber, a screw blade for transporting the white rice poured from the rice pouring port axially along the circumference wall of the centrifugal dehydration chamber, and a rinsing-water pouring port for pouring rinsing water toward the white rice transported by the screw blade; and the evaporation means is provided with a net rotatable in a freely driven mode so that the white rice fed from the rinsing dehydration means can be scattered on the net and also has an inhalation blower for inhaling air below the net.

By the way, usual brown rice has oil components of 2.8 g per 100 g on an average of Japanese rice, but the brown rice of the present invention has oil components of 2 g or less.

Further, the present invention intends to resolve by providing a producing method of modified brown rice, comprising the step of; giving an oppression state and a release state sequentially to brown rice in a space to transport brown rice in a given direction in the space, polishing quite thinly the surface of brown rice accumulated densely in the oppression state and mutually arranged in a longitudinal direction of the grain, and then polishing quite thinly the surface of brown rice, the position relation of which is mutually changed in the release state while the oppression is again given to cause a dense arrangement of brown rice; more, these steps are repeated to remove the pericarp and also partially remove the seed coat under the pericarp, thereby partially exposing the tubular cell tissues covered with the seed coat to the surface of brown rice.

Furthermore, in the above producing method of modified brown rice, polishing the epidermal layer of brown rice comprises the steps of; supplying brown rice to the polishing drum provided with the supplying port of brown rice on one end and the discharge port of brown rice on the other end and also provided with the axial-type polishing roll which rotates therein; polishing the epidermal layer of brown rice by the use of polishing carbide abrasive grains such as diamond, sapphire or zirconia ceramic fixed on the surface of the spiral protrusions mounted on the polishing roll; and while exposing the tubular cell tissues covered with the epidermal layer to the surface of brown rice, transporting the brown rice grains introduced from the supplying port into the polishing drum to the discharge port by using the spiral protrusions of the polishing roll.

More, the above producing method of modified brown rice may include removing oil components in tubular cell tissues exposed partially on the surface of brown rice.

Moreover, in any method of the above producing methods of modified brown rice, the removal of oil components in tubular cell tissues is performed by using a wash-free rice producing apparatus having a pressurizing stir means, a rinsing dehydration means and an evaporation means. In this wash-free rice producing apparatus, the pressurizing stir means has a water-pouring port for adding washing water to white rice and houses a stir roll provided with the spiral protrusions on the circumference surface in a freely rotating and driving mode inside a stirring drum provided with a receiving port for white rice on one end and a discharge port on the other end; the rinsing dehydration means has in a freely rotating and driving mode a centrifugal dehydration chamber provided with a porous circumference wall, in which a screw drum is provided coaxially with the centrifugal dehydration chamber and in a freely rotating and driving mode in relation to the centrifugal dehydration chamber, and a rice supplying tube for supplying white rice from the pressurizing stir means into the screw drum is passed through the screw drum, and the rinsing dehydration means has a rice pouring port for pouring the white rice supplied from the rice supplying tube toward the circumference wall of the centrifugal dehydration chamber, a screw blade for transporting the white rice poured from the rice pouring port axially along the circumference wall of the centrifugal dehydration chamber, and a rinsing-water pouring port for pouring rinsing water toward the white rice transported by the screw blade; and the evaporation means has a net rotatable in a freely driving mode so that the white rice fed from the rinsing dehydration means can be scattered on the net and also has an inhalation blower for inhaling air from the lower side of the net.

### BRIEF DESCRIPTION OF THE DRAWINGS

FIG. 1 is a fragmentary sectional view of modified brown rice according to an embodiment of the present invention;

FIG. 2 is a side view of a polishing roll;

FIG. 3 is an enlarged cross section of the main part of the polishing roll to which abrasive grains are fixed;

FIG. 4 is a side cross section of a brown rice processor;

FIG. 5 is a side view of a hull conveyor roll;

FIG. 6 is a front elevation of the hull conveyor roll viewed from an arrow A direction in FIG. 5;

FIG. 7 is an enlarged cross section of the main part of the polishing roll and a polishing drum for describing the dispersion state of brown rice grains;

FIG. 8 is a side cross section of brown rice processor comprising a water supplier;

FIG. 9 is an enlarged cross section of the main part of other polishing roll;

FIG. 10 is a front elevational cross section showing a part of a wash-free rice producing apparatus;

FIG. 11 is a cross section of a pressure stirring mill taken along the line A-A;

FIG. 12 is a longitudinal cross section of a rinse/dehydrator;

FIG. 13 is a front elevation of a screw drum;

FIG. 14 is a front elevation of an evaporator;

FIG. 15 is a cross section showing the rough structure of the conventional brown rice grain; and

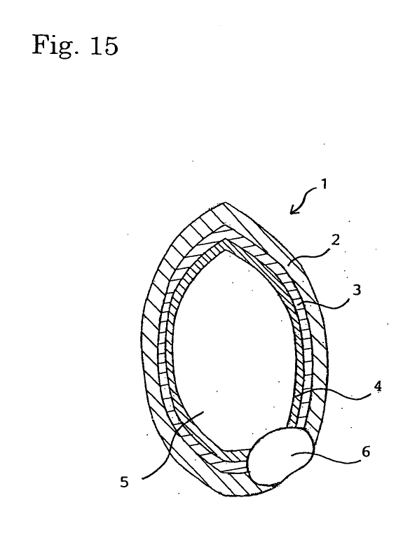

FIG. 16 is a model figure showing the structure of brown rice grain shown in FIG. 15 in more detail.

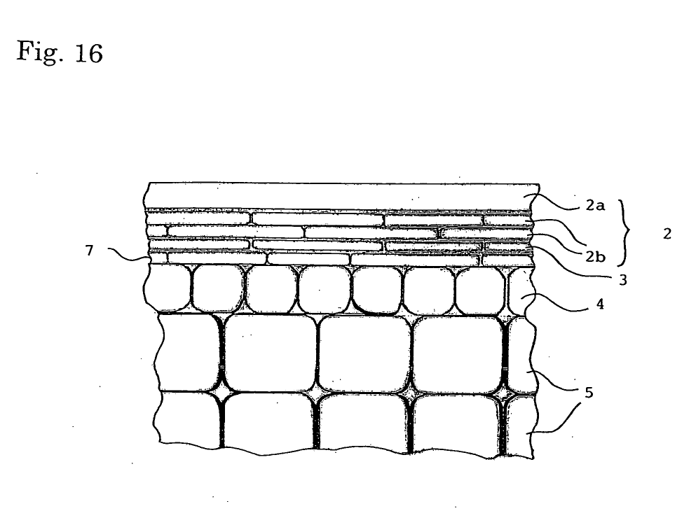

### DETAILED DESCRIPTION OF THE PREFERRED EMBODIMENT

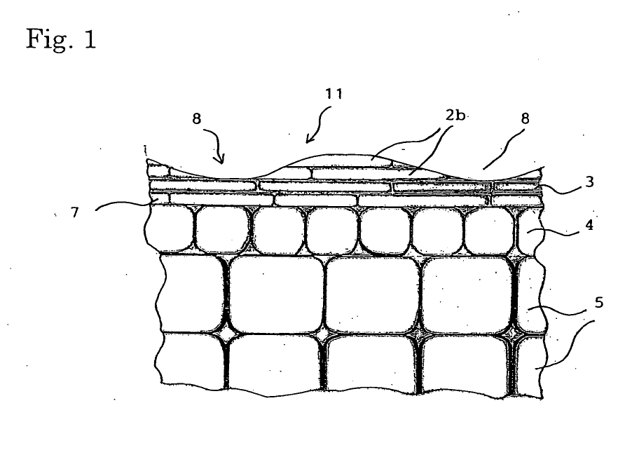

FIG. 1 is a fragmentary sectioned view showing a first embodiment of modified brown rice according to the present invention. In modified brown rice 11 in the figure, a pericarp of an epidermal layer is completely removed and a seed coat 2b covered by the pericarp is surfaced. A large number of small pores 8, 8 . . . are formed on the whole surface of the seed coat 2b reaching to the tubular cell tissue 3. Through the small pores 8, the tubular cell tissue 3 is to be partially exposed on the whole surface of brown rice. By forming such small pores 8, in the cooking process including the preparation of the rice, the moisture content penetrates and diffused into the inside the rice and pregelatinization of the starch by heating is uniformly preceded. Thus, it enables to obtain cooked brown rice with a pleasant taste and mouthfeel without requiring immersion of the rice in water for a long time as in the case of the conventional brown rice. It is also possible to polish and remove the seed coat 2b completely along with the pericarp. However, if the seed coat 2b is completely removed and the tubular cell tissue 3 is totally exposed to the surface, elution and the like from other parts are generated from an albumen 5 at the time of cooking since the tubular cell tissue 3 is easily exfoliated. Thus, the flavor and mouthfeel which are the important factors for determining the excellent taste may be lost due to deformation of brown rice grains, stickiness and the like caused by the elution. Also, the ingredients contained in the seed coat 2b are lost. By cooking it in the state where the rice grains are covered by the seed coat 2b in a net form by forming the small pores 8 and the tubular cell tissue 3, uniform expansion of each brown rice grain by heating can be achieved. Thereby, it enables to maintain the shape of each grain similar to that before being cooked so as to obtain an excellent taste and mouthfeel.

Removing the pericarp and forming the small pores 8 in the seed coat 2b may be achieved by polishing the epidermal layer of brown rice by an extremely small amount, i.e. grinding the part by a small amount. Thus, it is difficult to use friction-type rice polishing mills and the like since the epidermal layer, the mesocarp (tubular cell tissue), the inner bran layer and the like are exfoliated all together by rubbing the brown rice grains to each other.

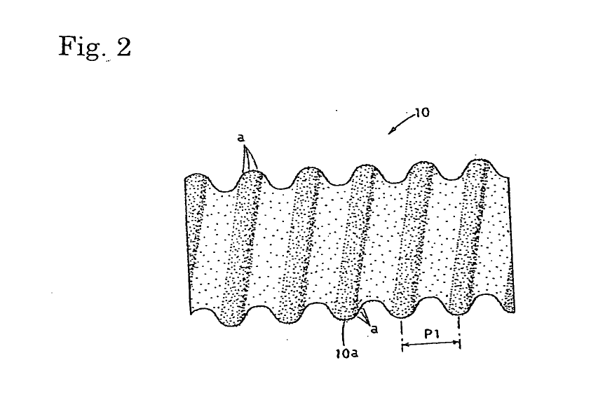

In the embodiment, removing of the pericarp and formation of the small pores 8 in the seed coat 2b are carried out using a brown rice processor shown in FIG. 2 to FIG. 9.

In the followings, the brown rice processor will be described by referring to the accompanying drawings. FIG. 2 shows a polishing roll of the processor according to the present invention. In the figure, the polishing roll shown by numeral 10 is formed in a hollow spindle using a metal material such as iron, and along the peripheral surface, a spiral ridge 10a is formed. P1 represents the pitch of the spiral ridge 10a.

The spiral ridge 10a is in a shape of a “knuckle thread” in which the top part is slightly flattened. It is formed in such a manner that the end edge of the cut section forms a substantial sine curve when the polishing roll 10 is cut by the plane going through the shaft line.

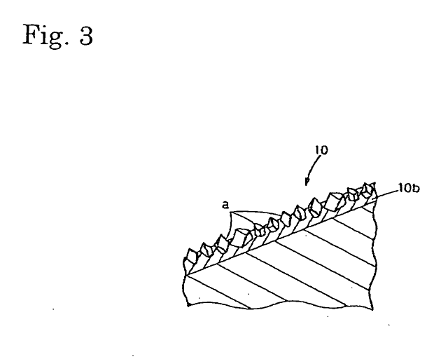

The polishing roll 10 comprises abrasive grains a all over the peripheral surface. As shown in FIG. 3, the abrasive grains a with the sharpened edge part being exposed are fixed to the polishing roll 10 through a metal-plating layer 10b (an example of fixing device) such as chrome and nickel formed on the surface of the polishing roll 10. This fixing method of the abrasive grains a is generally called “electrodeposition” and is a known technique. The materials for the abrasive grains a are not limited. However, in order to improve the durability of the polishing roll 10, it is desirable to use carbide abrasive grains with Mohs hardness of 9.5 or more such as diamond, sapphire, zirconia ceramics. Especially, it is more desirable to use diamond whose Mohs hardness is 10.

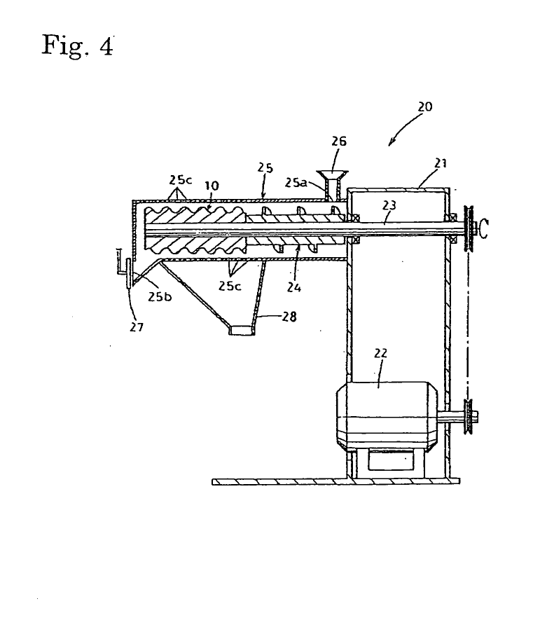

Next, an brown rice processor comprising the polishing roll 10 as described will be described by referring to FIG. 4 to FIG. 7. In FIG. 4, the brown rice processor shown by numeral 20 as a whole comprises: a processor main body 21; a motor 22; a rotary shaft 23 rotatably mounted onto the processor main body 21 for being driven to be operated by the motor 22. through a pulley and a belt; a hull conveyor roll 24 and the polishing roll 10, which are mounted on the part of the rotary shaft 23 projected towards the front side of the processor main body 21 while being fixed to the rotary shaft 23 by screws (not shown) or the like so as not to be rotated with the rotary shaft 23; and a polishing drum 25 mounted onto the processor main body 21 so as to cover the hull conveyor roll 14 and the polishing roll 10.

The polishing drum 25 is formed in a polygonal cylindrical shape (for example, a hexagonal cylindrical shape) or in a cylindrical shape while an inlet port 25a for the grains is formed on one side and a discharge port 25b is formed on the other side. Numeral code 25c represents a slit holes being formed in a large number in the part covering the polishing roll 10 of the polishing drum 25. Numeral 26 is a grain-feed hopper provided in the inlet port 25a while 27 is a resistance lid formed to face the discharge port 25b being energized to close the discharge port 25b by an energizing device (not shown) such as a spring. Numeral 28 is a polished-piece hopper provided underneath the polishing drum 25 being connected to a suction fan (not shown) or the like.

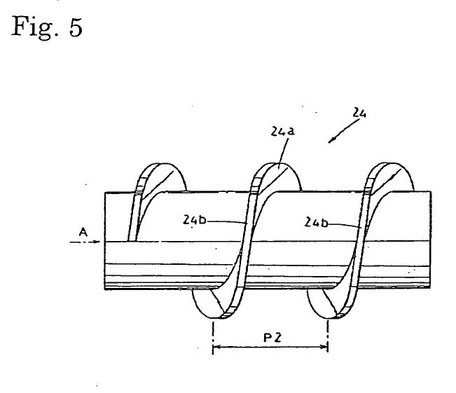

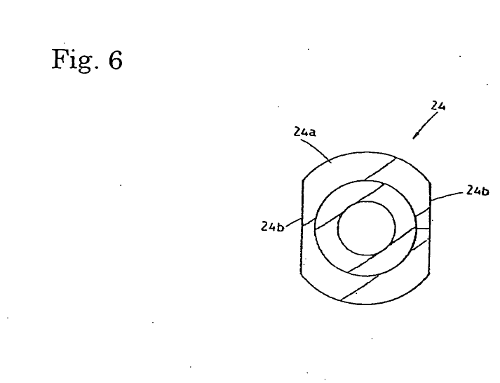

FIG. 5 and FIG. 6 show the hull conveyor roll 24. The hull conveyor roll 24 is formed in a hollow spindle shape using a metal material such as iron, while a spiral ridge 24a is formed along the peripheral surface. The spiral ridge 24a is formed in a thin blade shape and the pitch P2 is twice as much as the pitch P1 of the spiral ridge 10a of the polishing roll 10. Numeral code 24b represents a cutout part formed by cutting out a part of the spiral ridge 24a in a bow shape. As shown in FIG. 6, the cutout part 24b is formed symmetrically in right and left sides when the hull conveyor roll 24 is viewed from the front.

Next, the operation will be described. When the brown rice grains are supplied to the grain-feed hopper 26 by driving the rotary shaft 23 to rotate through the motor 22 in the counterclockwise direction with respect to the discharge port 25b, the brown rice grains are supplied from the inlet port 25a into the polishing drum 25 and then transported towards the discharge port 25b by the spiral ridge 24a on the hull conveyor roll 24 rotating integrally with the rotary shaft 23. The brown rice grains in between the peripheral surface of the polishing roll 10 and the inner surface of the polishing drum 25 are transported further to the discharge port 25b by the spiral ridge 10a of the polishing roll 10 which integrally rotates with the rotary shaft 23 and the surfaces are very slightly polished (ground) by the abrasive grains a of the polishing roll 10.

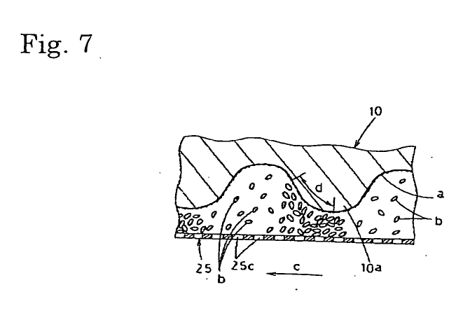

FIG. 7 is for explaining the state, where code b represents the brown rice grains and an arrow c shows the conveying direction of the brown rice grains b by the spiral ridge 10a. As described, the brown rice grains b are conveyed being in contact with the surface of the spiral ridge 10a on the lower reaches of the conveying direction in the cross section. Therefore, the brown rice grains b are pressed in between this surface and the inner surface of the polishing drum 25 to be in a high density and are very slightly polished (ground) in the dense state by the abrasive grains a. The residual pieces after the grinding are discharged from the polishing drum 25 through the slit holes 25c.

The brown rice grains b escaped from the space in between the top area of the spiral ridge 10a and the inner surface of the polishing drum 25 onto the back side of the spiral ridge 10a are to be in the low density state, so that these brown rice grains b become freely movable. Thus, the brown rice grains b are strongly turned around by the stirring action of the polishing roll 10, so that their positions are interchanged with each other.

As described, the brown rice grains b are conveyed while being ground and stirred in the polishing drum 25 in which a high-dense area and a low-dense area are alternately present. When reaching the discharge port 25b, the brown rice grains b push and open the resistance lid 27 opposing to the energizing force of the energizing device and go out of the polishing drum 25 through the discharge port 25b. As described, in brown rice processor 20 according to the present invention, the brown rice grains are polished (ground) in the dense state so that the facing direction of brown rice grains can be aligned to some extent. Therefore, they can be polished in the shape similar to those of the original brown rice grains. In other words, the surface of brown rice can be very slightly polished (ground).

When the carbide abrasive grains, specifically the diamond abrasive grains, are used, the durability of the abrasive grains a is extremely extended. However, after being used for a long time, the abrasive grains a shown by the code d in FIG. 7 on the lower reach side surface of the protrusion 10a in the grain conveying direction may be worn down and the sharpness may be lost. In such a case, according to the embodiment, the polishing roll 10 is once pulled out from the rotary shaft 23 and fitted back into the rotary shaft 23 to be fixed in the reverse direction. Thereby, the surface which used to be on the upper reach side of the protrusion 10a in the grain conveying direction with the abrasive grains a without being worn down can be used in the lower reach position. Therefore, compared to the one in which only one side of the protrusion 10a can be used, the life of the polishing roll 10 can be extended practically twice as much.

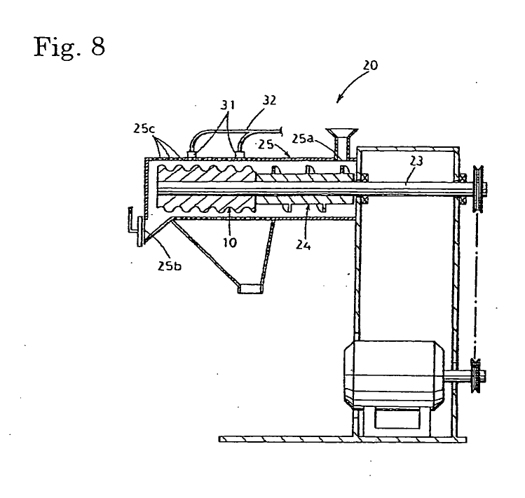

Further, the diamond abrasive grains are extremely hard but not vulnerable to high temperatures, so that the polishing roll 10 may be cooled for extending the life. FIG. 8 shows as brown rice processor 20 formed in such a manner that water in a prescribed flow amount from a hose 32 is supplied into the polishing drum 25 by attaching a water supplier 31 to the polishing drum 25 as an example of the cooling device. By supplying water from such water supplier 31 for applying water onto the surface of the polishing roll 10 through the brown rice grains, the polishing roll 10 is cooled down by water, so that the life of the diamond abrasive grains can be extended. The cooling device for cooling down the polishing roll 10 is not limited to this. For example, it is also possible without a question to form the rotary shaft 23 in a hollow shape for cooling down the polishing roll 10 by a cooling medium supplied through the hollow part.

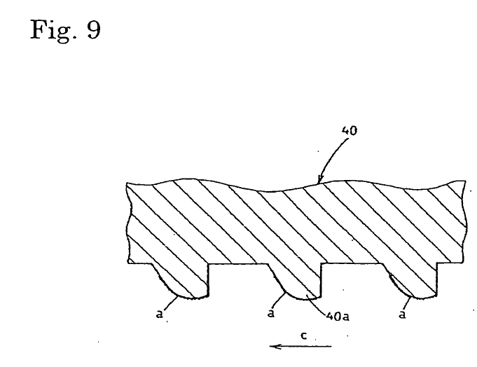

Also, the polishing roll may be in any forms. For example, when it is unnecessary to use the abrasive grains a on both sides of the spiral ridge 10a unlike the case of the polishing roll 10 as described, the abrasive grains a may be fixed only on the lower reach surface of a spiral ridge 40a in the grain conveying direction c as in a polishing roll 40 shown in FIG. 9. In this case, the upper reach surface of the spiral ridge 40a in the grain conveying direction may be in any shape.

However, it is desirable that the lower reach surface of the spiral ridge in the grain conveying direction slants to an extent as shown in FIG. 7 and FIG. 9. If this part is vertical, the brown rice grains cannot be compressed between with the inner surface of the polishing drum 25, so that the polishing efficiency becomes deteriorated. Further, it is desirable that the part from the lower reach surface in the grain conveying direction to the top part of the spiral ridge is formed in a gently curved surface. If there is a peaked area at an acute angle, only the abrasive grains in the peaked area are easily worn off or fallen off, which is not preferable.

Next, another embodiment of the modified brown rice according to the present invention will be described. The modified brown rice according to the present invention is formed in a hollow state in which oil and fat components inside the tube in the tubular cell tissue 3 shown in FIG. 1 are removed. By processing the tubular cell tissue 3 as described, moisture content is penetrated inside more quickly. In other words, as has been described, when the intake part of the end part of brown rice is in contact with water, the tubular cell tissue 3 does not take in water immediately. The tubular cell tissue 3 supplies water to the embryo bud 6 and the albumen 5 after being immersed in water for a prescribed time. The oil and fat components inside the tube in the tubular cell tissue 3 affect the action mechanism. Thus, by removing them, the moisture content can be smoothly permeated inside also from the intake part of the end part of brown rice through the tube of the tubular cell tissue 3.

The basic difference between brown rice such as 70% white rice or 30% white rice and the brown rice of the present invention obtained by this polishing process conventionally refers to the difference in the degree of the total rice bran component. On the contrary, the brown rice of the present invention is the one in which the rice wax part in the outer epidermal layer is almost completely removed by cutting out and grinding the rice bran by so-called a component grinding.

For achieving the process at the time of producing the brown rice, it requires an operation technique for: supplying the brown rice grains into the rice cleaning chamber more uniformly and under equal pressure compared to those at the time of conventional grinding; giving the high peripheral speed to the rice grains; and synchronizing with the polishing roll by keeping the speed of brown rice.

It is easy to discriminate the product of the present invention from the conventional product of brown rice (polished by some percentage) by the impurity degree of water when being immersed in the water.

The conventional brown rice with 30% polishing rate is 70 ppm or more while the brown rice according to the present invention is 60 ppm or less (see the measurement method of NIPPON SEIMAI KOGYOKAI).

In the embodiment, a following wash-free rice producing apparatus is used for removing the oil and fat component inside the tube for making a hollow part in the tubular cell tissue 3. In other words, the wash-free rice producing apparatus comprises a pressure stirring mill, a rinse/dehydrator and an evaporator. In the wash-free rice producing apparatus, the pressure stirring mill comprises a water inlet for applying a cleaning water to white rice and a stirring drum having a inlet port for the white rice on one end and an discharge port on the other in which a stirring roll having a protrusion on its peripheral surface being rotatably mounted inside. The rinse/dehydrator comprises a centrifugal dehydration chamber to be rotatable having a porous peripheral wall. Inside the centrifugal dehydration chamber, a screw drum is provided to be coaxial with the centrifugal dehydration chamber to be differentially rotatable with respect to the centrifugal dehydration chamber. In the screw drum, a grain supply pipe for supplying the white rice from the pressure stirring mill to the inside the screw drum is inserted. It also comprises: a grain discharge port for discharging the white rice supplied form the rice supply pipe towards the peripheral wall of the centrifugal dehydration chamber; a screw fan for moving the white rice discharged from the rice discharge port in the axial direction along the peripheral wall of the centrifugal dehydration chamber; and a rinse water discharge port for discharging the rinse water against the white rice moved by the screw fan. The evaporator comprises a net to be rotatable for spreading the white rice from the rinse/dehydrator on its top surface and a suction blower for suctioning air from the bottom side of the net.

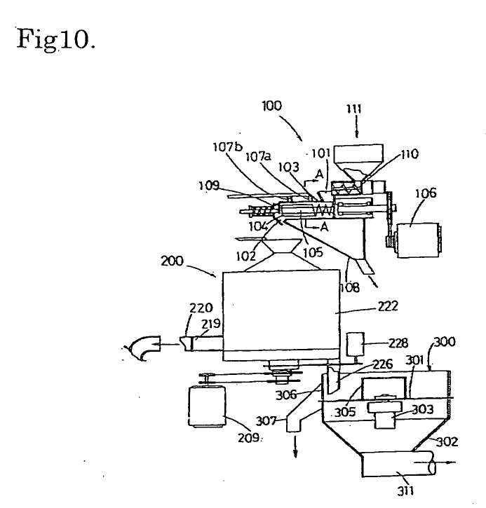

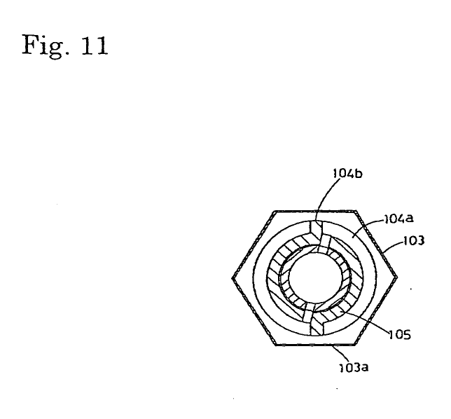

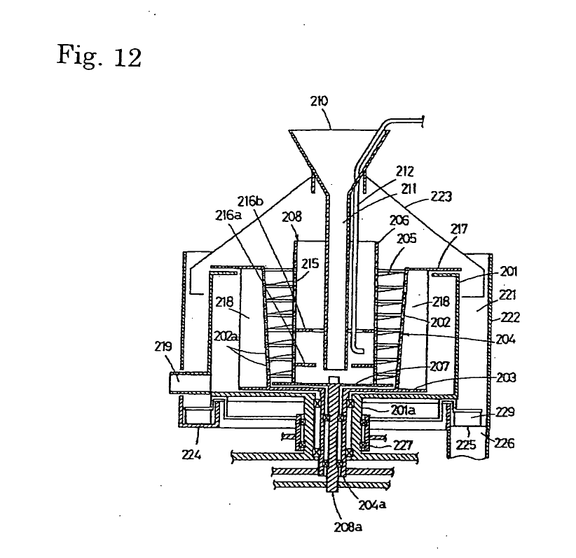

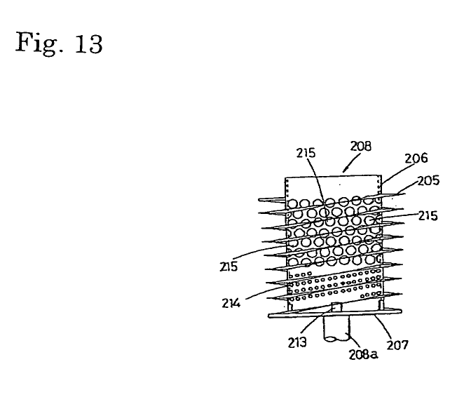

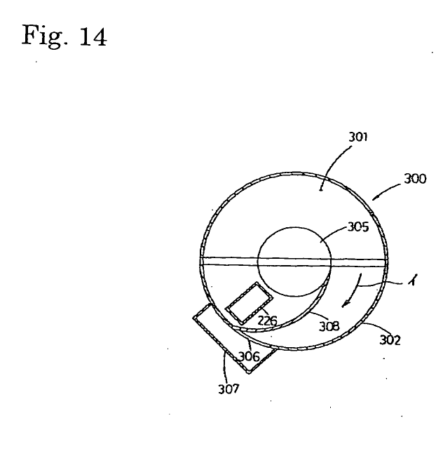

An embodiment of the wash-free rice producing apparatus will be described by referring to FIG. 10 to FIG. 14.

A pressure stirring mill 100 comprises a hexagonal cylindrical stirring drum 103 having an inlet port 101 for the white rice on one end and a discharge port 102 on the other inside which a stirring roll 105 having a protrusion 104 (feed protrusion 104a and stirring protrusion 104b) on its peripheral surface is mounted. The stirring roll 105 is provided to be rotatable by a motor 106. Water inlets 107a and 107b connected to a water tank (not shown) are provided in the stirring drum 103. A large number of small pores 103a about the size by which the brown rice grains are not escaped are provided on the lower side of the stirring drum 103. Further, a water receiving bucket 108 is placed thereunder and a pressure controlling mechanism 109 is provided in the discharge port 102. Numeral 110 is a screw feeder for adjusting the flow amount of brown rice and 111 is a rice feed port.

In a rinse/dehydrator 200, a centrifugal dehydration chamber 204 having a porous peripheral wall 202 in which small pores 202a about the size by which the brown rice grains do not escape and a bottom plate 203 is formed inside a casing 201 with the top surface being opened. Inside the centrifugal dehydration chamber 204, a screw drum 208 having a peripheral wall 206 with a screw fan 205 being formed outside and a bottom plate 207 is provided. At the same time, a hollow rotary shaft 204a of the centrifugal dehydration chamber 204 is fitted in a bearing 201a provided in the bottom of the casing 201 and a rotary shaft 208a of the screw drum 208 is fitted in the rotary shaft 204a to be rotatable freely, respectively, and each is driven by a motor 209 through a pulley and a belt. At this time, there is a difference in the diameter of the pulleys being provided so that the screw drum 208 rotates a little faster than the centrifugal dehydration chamber 204.

Further, a brown rice feed pipe 211 having an inlet port 210 on the upper end facing the discharge port 102 of the pressure stirring mill 100 and a rinse water supply pipe 212 connected to a water tank (not shown) and the like are inserted into the inside the screw drum 208 from the above. At the same time, corresponding to the bottom ends of the rice feed pipe 211 and the rinse water supply pipe 212, a rice discharge port 213 and a rinse water discharge port 214 are provided in the peripheral wall in order from the bottom and an air hole 215 is provided on the upper side than the rinse water discharge port 214. Between the rice grain discharge port 213 and the rinse-water discharge port 214, and between the rinse-water discharge port 214 and the air hole 215 are divided by providing partition walls 216a and 216b inside the peripheral wall 206.

Further, provided is a flange part 217 which is connected to the upper end of the peripheral wall 202 of the centrifugal dehydration chamber 204 and overlaps with the upper end of the peripheral wall of the casing 201 with a small space in between. A plurality of air fans 218 whose ends are supported by the flange part 217 and the bottom plate 203 and an exhaust/drain port 219 is provided in the lower part of the peripheral wall of the casing 201. Thereby, by the rotation of the centrifugal dehydration chamber 204, there is a flow of air generated from the top end of the screw drum 208 to the exhaust/drain port 219 through the air hole 215 and the small pores 202a. An exhaust/drain pipe 220 is connected to the exhaust/drain port 219.

An outer cover 222 is provided for covering the surrounding of the casing 201 with a space 221 in between and a rice-scatter-prevention net 223 is extended on the upper part of the outer cover 222 and a recovery bucket 224 is formed at the lower end of the outer cover 222 and a discharge pipe 226 is attached to a discharge port 225 provided in a recovery bucket 224. At the same time, a drive ring 227 fitted to a bearing 201a is provided to be rotatable by a motor 228 and the rice grains inside the recovery bucket 224 are made movable in the round direction by a plurality of gathering plates 229 supported by the drive ring 227.

An evaporator 300 is provided to be rotatable by a motor 303 mounted inside a casing 302 in which a circular plate type net 301 whose bottom surface is reinforced so as not to be deformed is provided facing the bottom end of the discharge pipe 226 of the dehydrator 200. The center part of the net 301 is covered by an inside cover 305 and a part of the casing 302 is cut out up to the height of the upper surface of the net 301 for forming a discharge port 306. A discharge chute 307 is fixed to the discharge port 306 while fixing a lead plate 308 for leading the white rice into the discharge port 306 by the rotation of the net 301.

The space between the bottom end of the discharge port 226 and the upper surface of the net 301 is to be in the size by which the brown rice grains do not pile up inside the discharge pipe 226 to be spread thin and widely on the net 301. Further, the size of the lower part of the casing 302. is reduced to be in a inverted cone shape and a suction port 311 connected to a suction blower (not shown) is provided in the bottom end.

Next, the operation under the above-described structure will be described. First, the brown rice after going through the process by the brown rice processor described above is inserted into the rice feed port 111. The inserted brown rice of the constant flow amount adjusted by a screw feeder 110 flows into the stirring drum 103 through the inlet port 101, then transferred to the direction of the discharge port 102 by the feed protrusion 104a of the rotating stirring roll 105 to be discharged from the discharge port 102 while the pressure is being adjusted by the pressure controlling mechanism 109. Meanwhile, the cleaning water from the water supply ports 107a and 107b is added while being stirred by the stirring protrusion 104b so that the polished piece on the surface of brown rice and the oil and fat components inside the tube in the tubular cell tissue 3 are separated from brown rice to be dissolved or suspended in the cleaning water. Most of the cleaning water is discharged from the small pores 103a of the stirring drum 103 and collected in the water receiving bucket to be processed. The brown rice with a little amount of cleaning water being attached is inserted to the inlet port of the rinse/dehydrator 200 when discharged from the discharge port 102.

The amount of the cleaning water from the water supply ports 107a and 107b may be a half or twice as much as the weight of brown rice. Further, it is possible to discharge the brown rice from the discharge port 102 after being in contact with the cleaning water in about 2 seconds or less. In such a short time process, the hardness of the brown rice is not deteriorated so that the brown rice can be processed by applying a relatively high pressure.

The brown rice inserted to the inlet port 210 falls down inside the rice supply pipe 211 and when reaching the bottom plate 207 of the screw drum 208, it is moved in the radial direction by the centrifugal force according to the rotation. Then, it is discharged from the rice discharge port 213 for entering inside the centrifugal dehydration chamber 204 to be pressed against the peripheral wall 202 by the centrifugal force of the rotation of the centrifugal dehydration chamber 204. The cleaning water attached to brown rice is discharged from the small pores 202a.

The drained brown rice is dehydrated by the centrifugal force while being transferred up in the axial direction along the peripheral wall 202 by a screw fan 205 of the screw drum 208 which differentially rotates with respect to the centrifugal dehydration chamber 204. During this process, the rinse water of about a half or twice as much of the weight of brown rice is applied. In other words, the rinse water supplied from the rinse water supply pipe 212 into the screw drum 208 is pressed against the inner surface of the peripheral wall 206 by the centrifugal force spreading between the partition walls 216a and 216b forming a water screen. This is discharged from the rinse water discharge port 214 to be showered over brown rice. It is poured while the centrifugal dehydration is performed so that the cleaning water containing the impurities attached onto the surface of brown rice can be effectively exchanged with the rinse water.

After the rinse water is poured over, the brown rice is further transferred up and the centrifugal dehydration is continued. At this time, it is possible to achieve dehydration only by the centrifugal force. However, in the embodiment, it is designed to assist the centrifugal dehydration effect by the air from the air port 215 to the small pores 202a going through in between brown rice grains. Thus, it enables to achieve quick dehydration without extremely increasing the centrifugal acceleration (G) so that the brown rice can be prevented from being damaged. The attached water may become 2 to 3 wt % of brown rice at the point of reaching the upper end of the centrifugal dehydration chamber 204.

The brown rice discharged form the upper end of the centrifugal dehydration chamber 204 is scattered in the radial direction by the centrifugal force and falls down to the recovery bucket 224 through the space 221. When reaching the discharge port 225 while being moved in the rotation direction by the gathering plate 229, it is discharged therefrom and falls down inside the discharge pipe 226.

The brown rice fallen inside the discharge pipe 226 reaches the net 301 of the evaporator 300 and is spread on the net 301 in order since the net 301 rotates in the direction of arrow τ. While being moved, the attached water is evaporated by air blown on the net from top down by the suction of the suction blower. When the brown rice is spread on the net 301, the amount of the attached water is very small being about 2 to 3 wt % of the white rice and, at the same time, it is attached uniformly on the whole surfaces of brown rice. Thus, the air flows uniformly between each space of the white rice so that there is no uneven drying may be caused. In the drying process, air is filled inside the tube of the tubular cell tissue 3 in which the oil and fat components are removed for forming a hollow part.

Also, the brown rice is not turned around so that the cell tissue of the epidermal layer of brown rice which has absorbed water and become fragile may not be damaged. When the brown rice in which the attached water is almost completely evaporated reaches the lead plate 308, it is lead to the discharge port 306 along the front face wall and discharged by falling down the chute 307.

The above-described is the processing procedure of brown rice according to the embodiment. Although it depends on the temperature of the cleaning water and the characteristics of brown rice as the ingredients, by completing this procedure within a short period of time such as 30 to 60 seconds from the time when the brown rice first comes to be in contact with the cleaning water, it is possible to appropriately suppress an increase of the moisture content rate against the brown rice as the ingredient. Therefore, it enables to obtain wash-free modified brown rice with an excellent quality.

In other words, the obtained modified brown rice can be cooked without washing. Also, inside the tube in the tubular cell tissue is processed so that the immersion time before cooking can be extremely shortened.

Even though the oil and fat components are removed from the processed brown rice, there are sufficient oil and fat components left in the remaining tubular tissue. Thus, the product may be oxidized during the preservation term. Therefore, it is desirable that the packaging of the product may be in a small content (1 kg or 2 kg) as much as possible. It is also desirable to be packed by an oxygen-free wrapping material to which a deoxidant material is enclosed and mixed.

In the modified brown rice according to the present invention, there is a rice wax film (paraffin film) on the surface and the seed coat containing the repellent substances such as guanine and jalapin is removed. Thus, it exhibits an excellent digestion and absorption while maintaining the same nutrient as that of the conventional brown rice. Further, the seed coat covered by the rice wax is removed, pores connecting through the tubular cell tissue are provided on the seed coat, and the tubular cell tissue is made to be hollow so that it can be cooked by the same manner as that of the ordinal white rice cooking only by setting the rate of the modified brown rice and water being 1:2 at the time of cooking. The seed coat with a small pores and the tubular cell tissue cover the inside as a net so that, during the heating process, the heat expansion is uniformly achieved without the deformation of brown rice grains. Therefore, it enables to achieve a complete pregelatinization of starch which is important in regards to the taste and the mouthfeel of the cooked rice and to appropriately form the dextrine film on the surface of the pregelatinized layer.

As described above, according to the present invention, it enables to achieve a modified brown rice which can be cooked in completely the same manner as that of the white rice and is excellent in taste, mouthfeel, and digestion and absorption, while containing almost the same nutrient components as that of so-called brown rice which is obtained by removing only the rice hulls from the rice plant. Thus, it promotes the effective utilization of brown rice and, further, improves the present situation where there has been a growing tendency to enjoy less rice.

1. Modified brown rice in which an epidermal layer of brown rice is polished to remove pericarp and also partially remove seed coat under the pericarp, thereby partially exposing tubular cell tissues covered with the seed coat on the surface of brown rice.

2. The modified brown rice of claim 1; wherein polishing the epidermal layer of brown rice is attained by a brown rice treating apparatus, comprising a polishing drum with a supplying port of brown rice on one end and a discharge port of brown rice on the other end, and an axial-type polishing roll which rotates inside the polishing drum, and the surface of the polishing roll is at least partially provided with spiral protrusions to which polishing carbide abrasive grains such as diamond, sapphire or zirconia ceramic are fixed, and having such a structure that while brown rice grains introduced from the supplying port into the polishing drum are transported by the spiral protrusions of the polishing roll toward the discharge port, polishing and grinding can be given only to the epidermal layer of brown rice.

3. The modified brown rice of claim 1, wherein oil components in tubular cell tissues are removed to give a hollow state therein.

4. The modified brown rice of claim 3; wherein oil components in tubular cell tissues are removed to attain hollowing in the tube by using a wash-free rice producing apparatus comprising a pressurizing stir means, a rinsing dehydration means and an evaporation means in the wash-free rice producing apparatus,
said pressurizing stir means has a water-pouring port for adding washing water to white rice and houses a stir roll provided with the spiral protrusions on the circumference surface rotatable in a freely driven mode inside a stirring drum provided with a receiving port for white rice on one end and a discharge port on the other end;
said rinsing dehydration means is rotatable in a freely driven mode provided with a centrifugal dehydration chamber provided with a porous circumference wall, in which a screw drum is provided coaxially with the centrifugal dehydration chamber and rotatable in a freely driven mode in relation to the centrifugal dehydration chamber, and a rice supplying tube for supplying white rice from the pressurizing stir means into the screw drum is passed through the screw drum, and said rinsing dehydration has a rice pouring port for pouring the white rice supplied from the rice supplying tube toward the circumference wall of the centrifugal dehydration chamber, a screw blade for transporting the white rice poured from the rice pouring port axially along the circumference wall of the centrifugal dehydration chamber, and a rinsing-water pouring port for pouring rinsing water toward the white rice transported by the screw blade;
and said evaporation means is provided with a net rotatable in a freely driven mode so that the white rice from the rinsing dehydration means can be scattered on the net and also has an inhalation blower for inhaling air below the net.

5. A method for producing modified brown rice, comprising the steps of;
giving an oppression state and a release state sequentially to brown rice in a space to transport brown rice in a given direction in the space, polishing quite thinly the surface of brown rice accumulated densely in the oppression state and mutually arranged in a longitudinal direction of the grain, and then polishing quite thinly the surface of brown rice, the position relation of which is mutually changed in the release state while the oppression is again given to cause a dense arrangement of brown rice, wherein these steps are repeated to remove the pericarp and also partially remove the seed coat under the pericarp, thereby partially exposing the tubular cell tissues covered with the seed coat to the surface of brown rice.

6. The method for producing modified brown rice of claim 5, polishing the epidermal layer of brown rice comprising the steps of:
supplying brown rice to the polishing drum provided with the supplying port of brown rice on one end and the discharge port of brown rice on the other end and also provided with the axial-type polishing roll which rotates therein;
polishing the epidermal layer of brown rice by the use of polishing carbide abrasive grains such as diamond, sapphire or zirconia ceramic fixed on the surface of the spiral protrusions mounted on said polishing roll; and while exposing the tubular cell tissues covered with the epidermal layer to the surface of brown rice, transporting the brown rice grains introduced from the supplying port into the polishing drum to the discharge port by using the spiral protrusions of the polishing roll.

7. The method for producing modified brown rice of claim 5, wherein oil components in tubular cell tissues which are partially or totally exposed to the surface of brown rice are further removed to attain hollowing therein.

8. The method for producing modified brown rice of claim 5; wherein oil components in tubular cell tissues are removed to attain hollowing therein by using a wash-free rice producing apparatus comprising a pressurizing stir means, a rinsing dehydration means and an evaporation means, and more particularly, in the wash-free rice producing apparatus, said pressurizing stir means has a water-pouring port for adding washing water to white rice and houses a stir roll provided with the spiral protrusions on the circumference surface rotatable in a freely driven mode inside a stirring drum provided with a receiving port for white rice on one end and a discharge port on the other end;
said rinsing dehydration means is rotatable in a freely driven mode provided with a centrifugal dehydration chamber provided with a porous circumference wall, in which a screw drum is provided coaxially with the centrifugal dehydration chamber and rotatable in a freely driven mode in relation to the centrifugal dehydration chamber, and a rice supplying tube for supplying white rice from the pressurizing stir means into the screw drum is passed through the screw drum, and said rinsing dehydration has a rice pouring port for pouring the white rice supplied from the rice supplying tube toward the circumference wall of the centrifugal dehydration chamber, a screw blade for transporting the white rice poured from the rice pouring port axially along the circumference wall of the centrifugal dehydration chamber, and a rinsing-water pouring port for pouring rinsing water toward the white rice transported by the screw blade;
and said evaporation means has a net rotatable in a freely driven mode so that the white rice from the rinsing dehydration means can be scattered on the net and also has an inhalation blower for inhaling air below the net.

9. The modified brown rice of claim 2, wherein oil components in tubular cell tissues are removed to give a hollow state therein.

10. The method for producing modified brown rice of claim 5, wherein oil components in tubular cell tissues which are partially or totally exposed to the surface of brown rice are further removed to attain hollowing therein.
